(19) United States
(12) Patent Application Publication
(10) Pub. No.: US 2010/0157581 A1
(43) Pub. Date: Jun. 24, 2010

(54) FLASHLIGHT WITH CLIP INTERFACE

(76) Inventor: Robert D. Galli, North Kingstown, RI (US)

Correspondence Address: BARLOW, JOSEPHS & HOLMES, LTD., 101 DYER STREET, 5TH FLOOR, PROVIDENCE, RI, 02903, US

(21) Appl. No.: 12/698,618

(22) Filed: Feb. 2, 2010

Related U.S. Application Data
(63) Continuation-in-part of application No. 11/856,432, filed on Sep. 17, 2007.
Application No. 11/856,432 is a continuation of application No. 11/067,187, filed on Feb. 26, 2005, now Pat. No. 7,287,873.
(60) Provisional application No. 60/557,234, filed on Mar. 29, 2004.

(51) Int. Cl. F21L 4/00

(52) U.S. Cl. 362/158; 362/396

(57) ABSTRACT

A lighting assembly is provided that includes a novel modular interface arrangement that allows the flashlight to be interfaced with a variety of different equipment or reconfigured in order to facilitate use for different functionality such as a marker light, a runway indicator light or a weapon mounted light.

### CROSS-REFERENCE TO RELATED APPLICATIONS

This application is a continuation-in-part of and claims priority from earlier filed U.S. Utility application Ser. No. 11/856,432, filed Sep. 17, 2007, which claims priority from earlier filed U.S. Utility application Ser. No. 11/067,187, filed Feb. 26, 2005, which claims priority from U.S. Provisional Patent Application No. 60/557,234, filed Mar. 29, 2004.

### BACKGROUND OF THE INVENTION

The present invention relates generally to a sealed flashlight assembly. More specifically, the present invention relates to a new portable flashlight assembly and more particularly to compact flashlight assembly that is highly durable and completely sealed against the effects of environmental pressure changes while also being constructed for easy mounting and integration into a variety of applications.

Typically, in prior art flashlights manufactured for use underwater, one of the major problems is making the assembly watertight. Waterproofing the operable components of the switch tends to be particularly troublesome. Often rubber diaphragms and covers have been used as outer seals and the switch must be operated through the seal. After prolonged use, these seals wear and are prone to leakage. Other parts, such as removable ends for replacement of battery and bulb, also must be sealed and servicing the unit often results in damage to or destruction of the seals. Further, if these flashlights are configured for use in deep water at depths approaching 350 feet below sea level, they typically require a pressure-equalizing valve to prevent them from imploding from the force of the surrounding environmental pressures. This problem is further complicated when the same light is also required to operate at high altitudes such as at 35,000 feet above sea level. Again, a pressure-equalizing device must be incorporated to prevent the light from exploding from a build up of internal pressures. Generally, the pressure-equalizing device used for underwater applications will fail at high altitudes and the high altitude device will fail in deep water.

These pressure equalization issues are exacerbated by the fact that the portable flashlights in the prior art typically include a cylindrical housing that encloses the light source, power source, required circuitry, the operable switch element and a relatively large volume of air. It is this volume of air that has the greatest effect on the ability of the flashlight to transition from high altitude operation to deep-sea operation. Further, the slide type switch or a spring loaded button type switch of these prior art flashlights require that a portion of the operable components reside on the exterior of the light while another portion is positioned on the interior resulting in a weak point at the interface between these operable elements.

Accordingly, there is a need for a flashlight that substantially eliminates the operational disadvantages of prior art flashlights. There is also a need for a flashlight that has a hermetically sealed interior that eliminates substantially all of the air from the interior of the flashlight while also preventing the entry of moisture thereinto. There is a further need for a flashlight that can be actuated using interior and exterior components that do not require a physical interface thereby eliminating a weak point in the housing. There is yet a further need for a sealed flashlight that can serve a variety of different functional needs and provide an ability to interface with a broad range of other equipment.

### BRIEF SUMMARY OF THE INVENTION

In this regard, the present invention provides for a novel lighting assembly that incorporates a high brightness LED in a compact assembly that is sealed and sufficiently durable for a continuous operational range of between 350 feet below sea level and 35,000 feet above sea level. The light includes at least one high brightness light emitting diode to provide high intensity light. The output range may be in any visible light color. Preferably, the output will be in the visible white range either by using an Indium Gallium Nitride/Gallium Nitride chip with a phosphor coating such as a Nichea white LED. Similarly, as would be obvious in the art other white LED's could easily be substituted for the same effect. For example, an Aluminum Indium Gallium Arsenide LED could easily be substituted. Further, any other white light source such as incandescent, halogen or xenon could also be used.

The flashlight may also include auxiliary lighting functions in combination with or in place of the white light element. The present invention may also include a red light diode for night vision operations, an infrared diode for use in conjunction with night vision goggles or a laser diode for automated firing or targeting systems. Any of these features may be included either alone or in combination in the flashlight of the present invention.

Further, the flashlight of the present invention includes a novel modular interface arrangement that allows the flashlight to be interfaced with a variety of different equipment or reconfigured in order to facilitate use for different functionality such as a marker light, a runway indicator light or a weapon mounted light.

It is therefore an object of the present invention to provide a flashlight that has an operational range that exceeds the operational limits encountered with prior art flashlights. It is a further object of the present invention to provide a flashlight that has a hermetically sealed interior and which eliminates substantially all of the air from the interior of the flashlight while also preventing the entry of moisture thereinto. It is yet a further object of the present invention to provide a flashlight that can be actuated using interior and exterior components that do not require a physical interface thereby eliminating a weak point in the housing. It is still a further object of the present invention to provide a sealed flashlight that can serve a variety of different functional needs and provide an ability to interface the flashlight with a broad range of other equipment and accessories.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of the flashlight of the present invention;

FIG. 2 is a front view of the flashlight of the present invention with the modular accessory mount removed;

FIG. 3 is a bottom perspective view of the flashlight of the present invention with a modular clip installed in place of the modular accessory mount;

FIG. 4 is a bottom perspective view of the flashlight of the present invention with the modular clip removed;

FIG. 5 is a perspective view of the flashlight of the present invention received on a belt using the modular interface;

FIG. 6 is a perspective view of the flashlight of the present invention with a lanyard attached to the modular accessory mount;

FIG. 7 is a perspective view showing a gimbal installed on the modular accessory mount;

FIG. 8 is a perspective view showing a clip received in place of the modular accessory mount;

FIG. 9 is a front view showing a stake installed on the modular accessory mount and a diffuser installed over the output end of the flashlight;

FIG. 10 is an exploded perspective view showing the flashlight, stake and diffuser;

FIG. 11 is a cross-sectional view taken along line 11-11 of FIG. 1;

FIG. 12 is a top perspective of an alternate embodiment of the flashlight of the present invention;

FIG. 13 is a bottom perspective of the flashlight of FIG. 12;

FIG. 14 is a bottom perspective of the flashlight of FIG. 12 with the modular interface removed;

FIG. 15 is a cross-sectional view taken along Line 15-15 of FIG. 14;

FIGS. 16a-16e illustrate a sequence of operation for the clip on the modular interface; and

FIG. 17 is a top perspective of the flashlight of the present invention with an alternate modular interface.

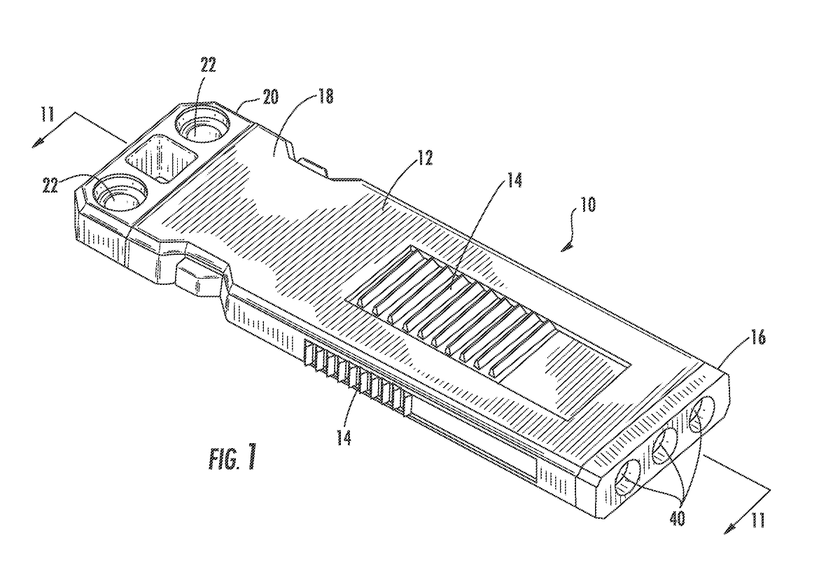

### DETAILED DESCRIPTION OF THE INVENTION

Now referring to the drawings, the lighting assembly of the present invention is shown and generally illustrated in the figures as 10. The lighting assembly 10 is the central component for the modular system described herein. The lighting assembly 10 can be seen to include an outer housing 12, at least one slide switch 14, a head assembly 16 and a modular interface 18 for receiving various modular accessories including the modular accessory mount 20 shown.

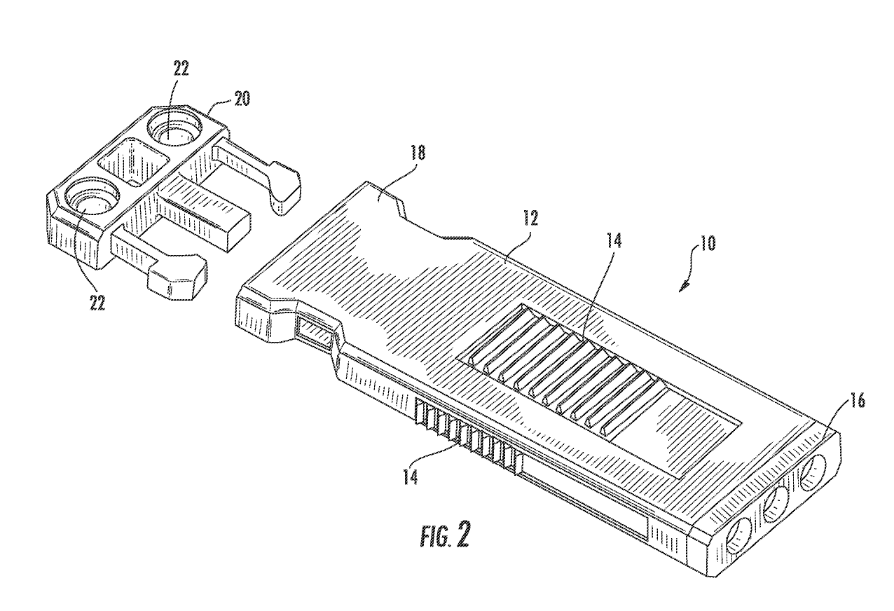

The outer housing 12 of the lighting assembly 10 of the present invention is configured in a novel manner to allow its integration into various systems and configurations. The outer housing 12 is formed to include a modular interface 18 that serves as one end of a detachable clip element. As can best be seen in FIG. 2, the modular interface 18 is shown as being formed as a female receptor end of a detachable clip assembly. Similarly, although not shown, the modular interface 18 provided on the housing 12 of the lighting assembly 10 may be formed as a male end. This allows the corresponding male or female portion to be formed on a variety of other devices such as a modular accessory mount 20. By providing a modular interface 18, the lighting assembly 10 can easily be mounted and de-mounted allowing modular accessories to be interfaced with the lighting assembly 10 as desired.

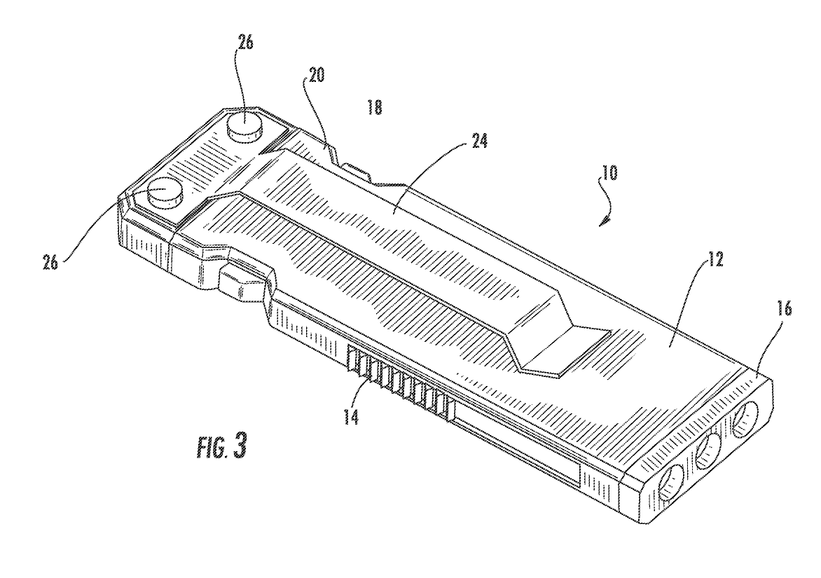

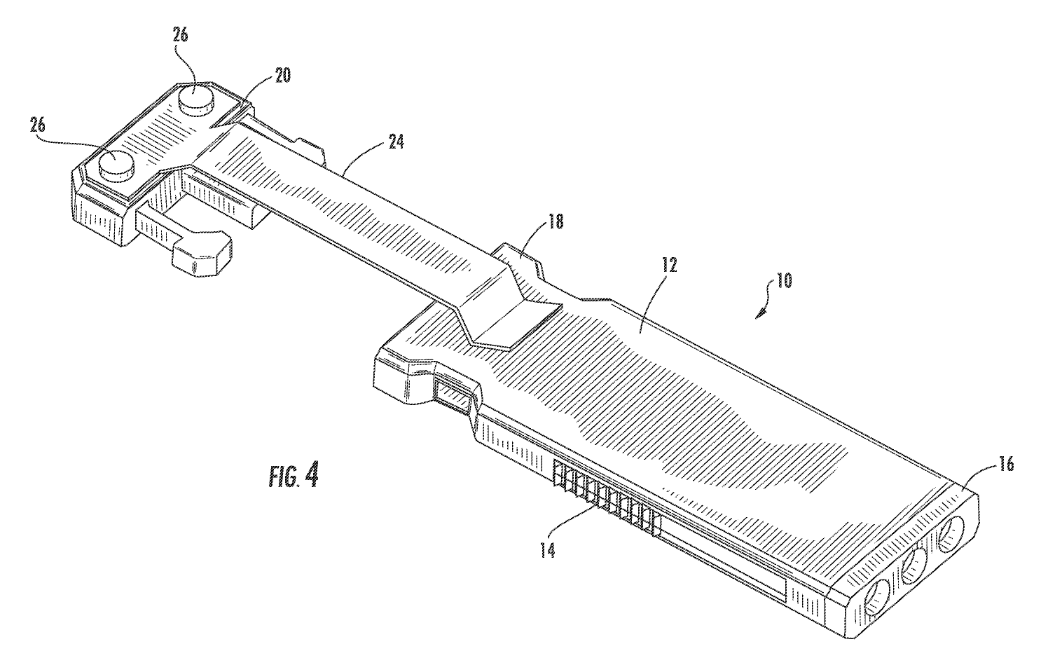

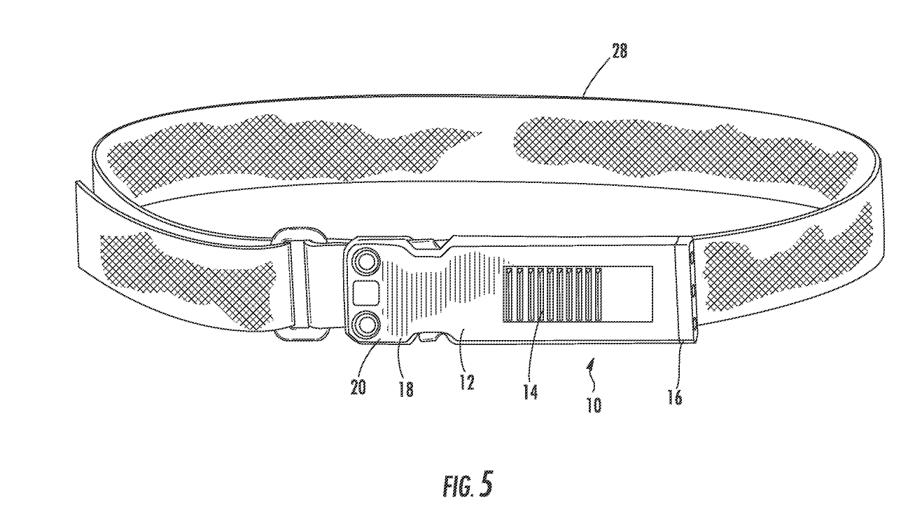

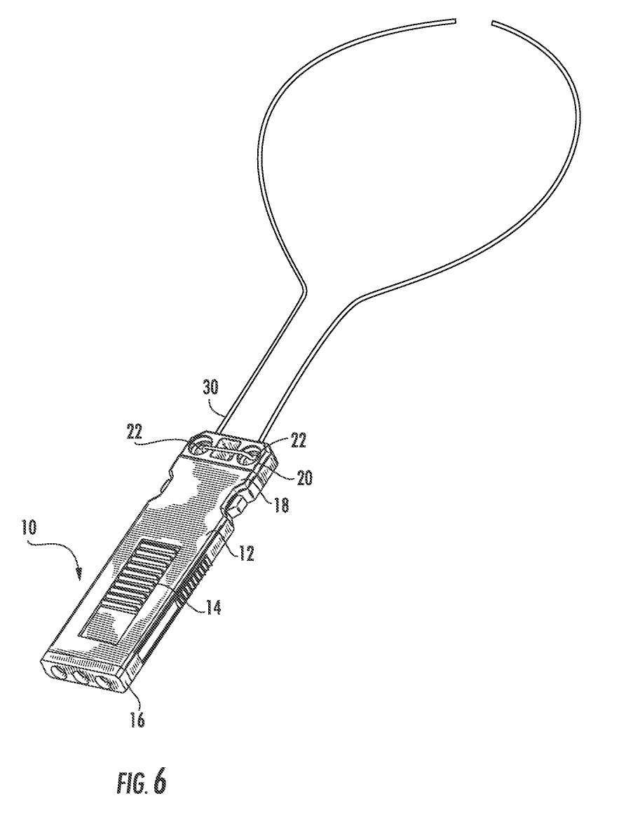

The modular accessory mount 20 in its simplest form may be a clip with holes 22 provided therein to facilitate attachment of other accessories. FIGS. 3 and 4 illustrate a clip accessory 24 that is attached to the modular accessory mount 20 by installing fasteners 26 into the holes 22. Optionally, accessories may be joined with the accessory mount 22 by riveting, heat staking or direct molding. Similarly, FIG. 5 illustrates the modular accessory mount 20 attached to a belt or strap 28 with the lighting assembly 10 engaged onto the accessory mount 20. In this manner, the strap 28 can be worn as a belt, an armband or a headband allowing the lighting assembly 10 to be worn on in a convenient location by the user. FIG. 6 illustrates a lanyard loop 30 that is passed through the holes 22 in the accessory mount 20 allowing the lighting assembly 10 to be worn around the user's neck or tied in a desired hanging location. FIG. 7 further illustrates a swivel or gimbal 32 that is mounted into the rear of the accessory mount 20. The swivel 32 is also capable of receiving a lanyard loop 30 in the hole 34 provided therein if desired. FIG. 8 alternately shows that the accessory mount 20 may be formed into different configurations such as a key ring extension 21 with a spring type lock 23.

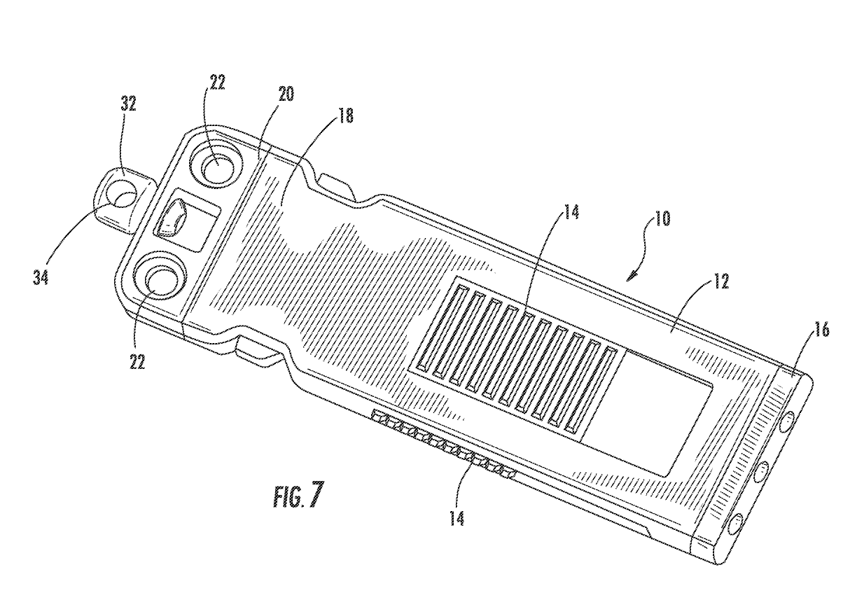

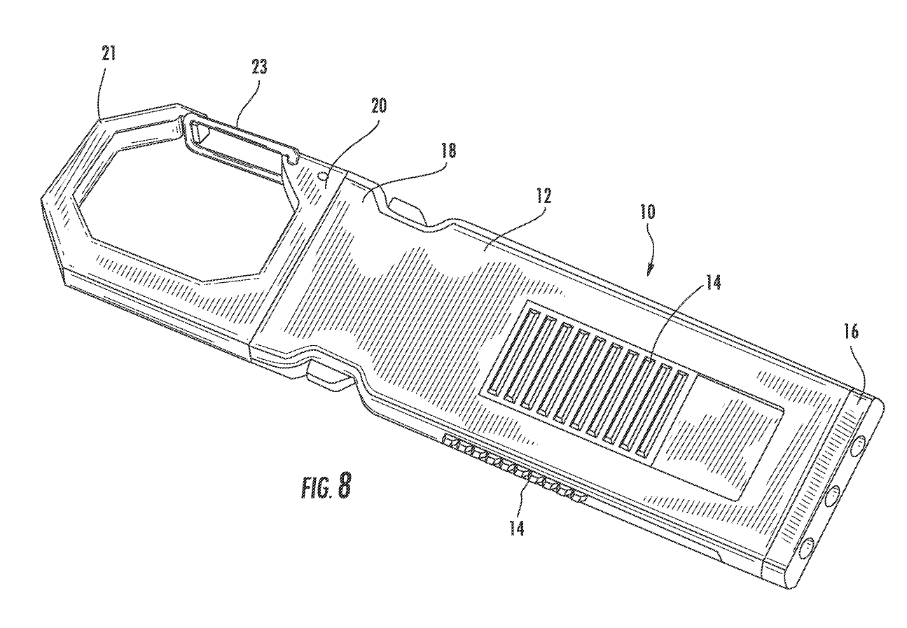

Turning now to FIGS. 9 and 10, to further tailor the lighting assembly 10 to the desired military applications, the accessory mount 20 is shown coupled to a stake 36 to allow the lighting assembly 10 to be staked into a desired location on the ground. The stake 36 allows the lighting assembly 10 to be positioned in a manner that allows it to serve as a locator beacon or a runway marker. To enhance the operation as a runway marker, a diffuser element 38 is shown installed over the output end of the lighting assembly 10.

Turning to FIG. 11, the internal components and the operation of the lighting assembly 10 is illustrated. The lighting elements 40 are mounted to a circuit board 42 and extend through openings 44 in a head assembly 16. As was stated above, the preferred lighting element 40 is a high intensity white LED, although any diode element available on the market including an LED in the visible range, an infrared diode, an ultraviolet diode or a laser diode may also be incorporated into the lighting assembly 10 and still fall within the scope of the present invention. The joint around the LED 40 optical portion is sealed using a potting compound 46, silicon or epoxy material. Also contained on the circuit board 42 are magnetic sensor elements 48 such as Hall effect sensors or mechanical reed switches, operational circuitry and a power source 50 such as a high capacity coin cell battery. The circuit board 42 and head 16 are placed into a housing enclosure 12. The void 52 within the enclosure 12 is then injected with a potting compound such as an epoxy or a silicone material to seal the entire assembly and evacuate any air within the housing 12. To further enhance the sealing process and evacuate any air, the lighting assembly 10 may be placed in a vacuum environment before injecting the sealant material.

Operation of the lighting device 10 is accomplished using slide switches 14 placed on the exterior of the housing 12. The slides 14 have magnets 54 therein that are positioned above the magnetic sensors 48. Depending on the specific position of the magnet 54 relative to a particular sensor 48, the circuitry on the circuit board 42 will operate the lighting assembly 10 in a particular manner. For example, one switch 14 may determine which lighting function will operate while another slide 14 may regulate intensity and a third slide 14 would control function such as constant on or strobe.

Each switch slide 14 may use any number of sensors 48 and/or magnets 54 from at least one to any greater number, depending on the number of functions desired to be controlled by the switch assembly 14. The sensors 48 are all electrically connected to a computer logic chip 56 via circuit traces on the surface of the circuit board 42. When a magnet 54 is placed directly above one of the sensor positions 48 the sensor 48 detects a magnetic field generated by the magnet 54 and creates an “ON” condition that is sensed by the computer chip 56. In the same manner an array of magnets 54 may be provided in the slide actuator 14 that can be selectively positioned over the array of sensors 48 to create numerous combinations of “ON” and “OFF” codes.

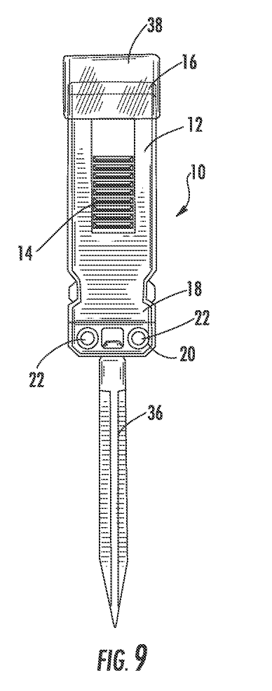

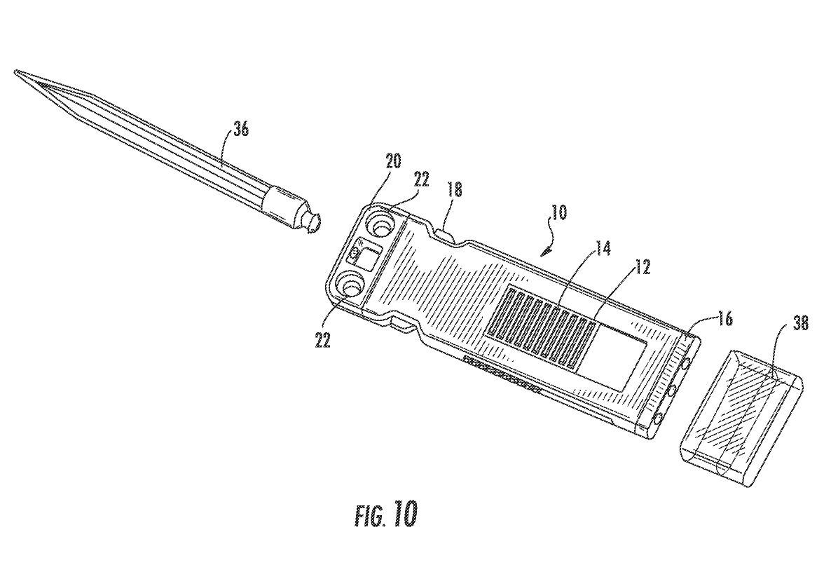

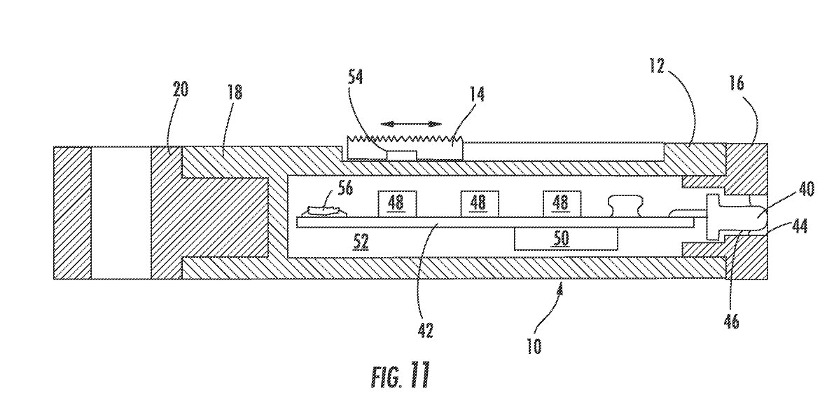

In an alternate embodiment of the flashlight of the present invention depicted generally at FIGS. 12-16, the lighting assembly 100 can again be seen to include an outer housing 112 that is configured in a novel manner to allow its integration into various systems and configurations. The outer housing 12 is formed to include a modular interface 118 that serves as one end of a detachable clip element. As can best be seen in FIGS. 14 and 15, the modular interface 118 is formed to include an at least one opening 119 therein that is formed as a female receptor end of a detachable clip assembly. This allows the corresponding male portion to be formed on a variety of other devices such as a modular accessory mount 120. While two openings 119 are shown here it should be appreciated that such a configuration is presented so that the housing 112 includes an interior wall 113 that increases the structural rigidity of the lighting device 100 and serves to create two separate compartments 111 into which the batteries 115 can be received. In this manner, the male portion of the accessory mount 120 is formed as two corresponding plugs 121 that are received into the openings 119 in the two separate compartments 111 as will be described in more detail below. Similarly, the interior wall 113 could easily be eliminated forming a singular battery compartment 111 and the corresponding plug 121 would be formed as a single element. To further assist in retaining the accessory mount 120 on the lighting device 100, a spring clip 123 can be seen at FIG. 13. The spring clip 123 interfaces with the detent 125 to assist in preventing the accessory mount 120 from being dislodged from the lighting device 100. By providing a modular interface 118, the lighting assembly 100 can easily be mounted and de-mounted allowing modular accessories to be interfaced with the lighting assembly 100 as desired.

The accessory mount 120 in this arrangement also serves as the rear contact for the batteries 115. A conductor 17 can be seen extending through the rear of the accessory mount 120 to provide conductivity between the two rear terminals of the batteries 115 when the accessory mount 120 is installed onto the lighting device 100. The arrangement also allows additional accessories to be installed onto the lighting device 100 in a manner that they provide switching control over the lighting device 100 as will be described with respect to a tape switch accessory below.

The operation in this embodiment of the lighting device 100 has also been changed. Rather than a magnetic slide, a push button 107 and mode indicator 109 have been provided. The lighting device 100 is multi functional in that it may include the ability to illuminate in a variety of different colors including but not limited to white, red, blue, green, infrared, ultraviolet, etc, and in a variety of different modes including but not limited to constant on, momentary on, strobe, high, low, etc. Various sequences of pressing and holding the pushbutton 107 cause the mode and/or color of the illumination device 100 to change such that the indicator 109 provides visual feed back to the user as to which mode the lighting device 100 is set for. For example, the color of the indicator 109 may indicate the color in which the lighting device 100 itself will illuminate.

Turning now to FIG. 15, the modular accessory mount 120 is shown as a clip accessory 124. The clip accessory 124 is preferably retained within the accessory mount 120 such that it can be rotated relative to the accessory mount 120. Further a spring 127 can be seen in a position that spring biases the clip accessory 124 against the accessory mount 120. In the closed position, the clip accessory 124 can be seen to have a first end that engages with the accessory mount 120 and a second end that is retained within the accessory mount and is maintained in contact therewith due to the tension of spring 127. To further assist in preventing the clip accessory 124 from being accidentally displaced relative to the accessory mount 120 a male formation 129 can be seen provided on the first end of the clip accessory 124 and a corresponding female formation 130 is provided on the accessory mount 120. When the clip accessory 124 is in the closed position, the male formation 129 engages the female formation 130 to prevent accidental rotation of the clip accessory 124.

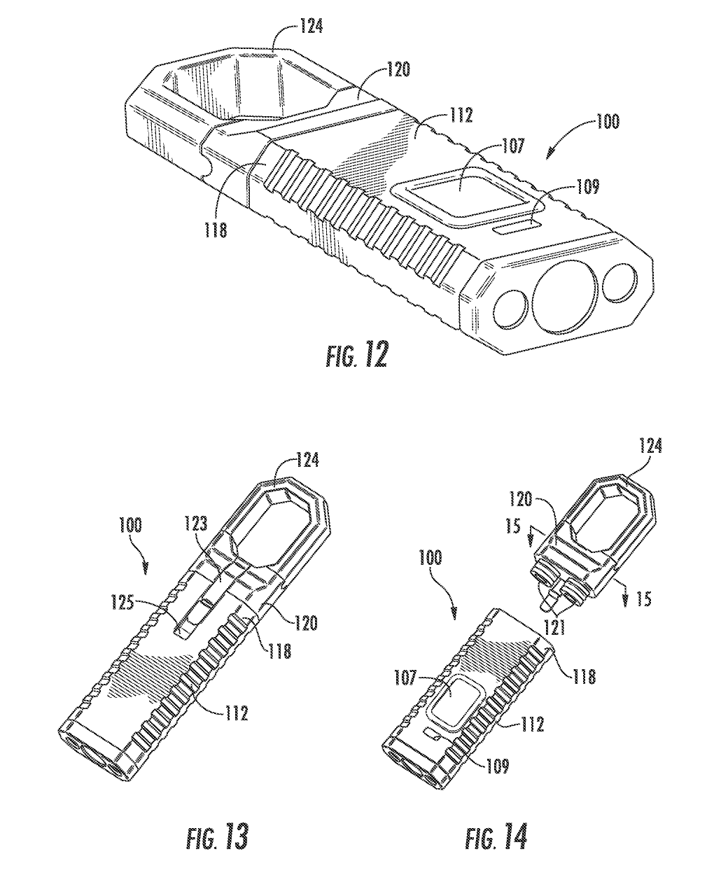

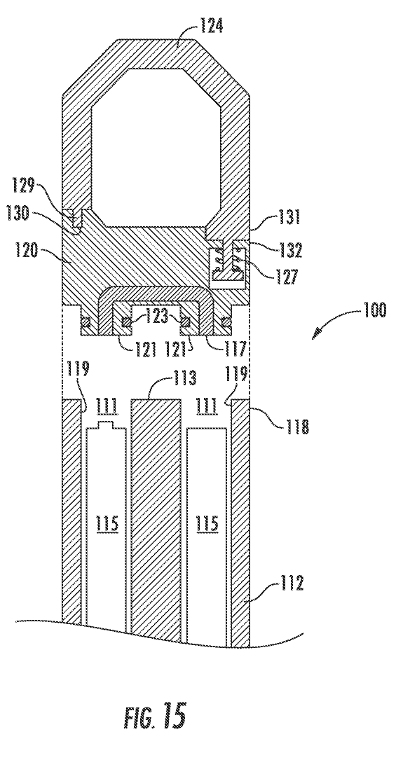

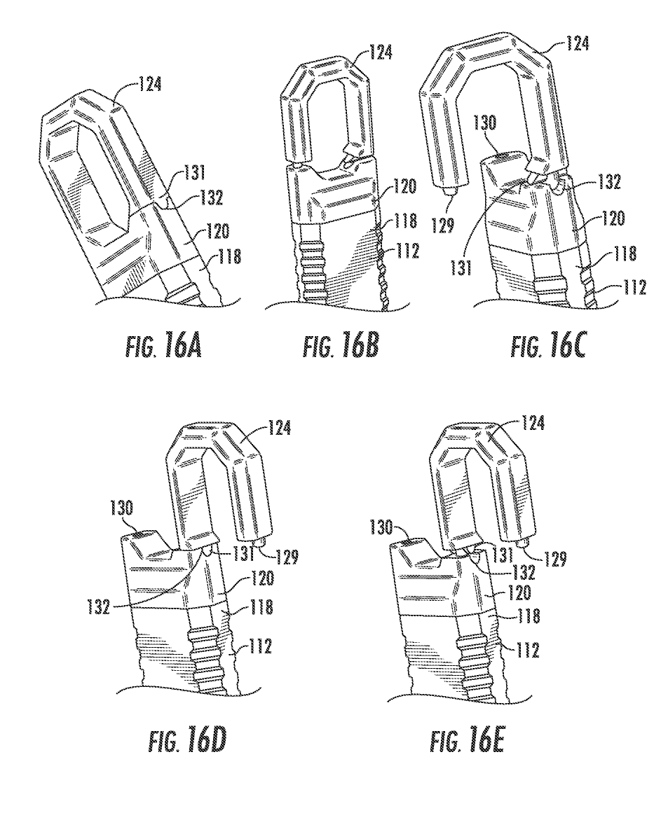

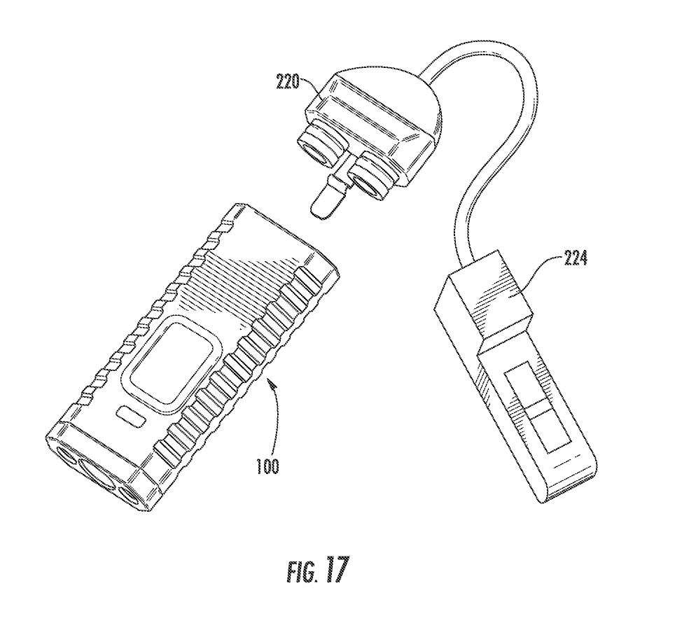

The clip accessory 124 also includes a key formation 131 on its second end that engages with a keyway 132 provided on the accessory mount 120. The key formation 131 drops into the keyway 132 when the clip is in either the fully open position or the fully closed position retaining the clip accessory 124 in the desired rotational position with regard to the accessory mount 120. As can best be seen thin the sequence of FIGS. 16a-16e, at FIG. 16a the clip accessory 124 is fully closed. At FIG. 16b, the clip accessory 124 has been displaced away from the accessory mount 120 against the spring 127 thereby disengaging the male formation 129 from the female formation 130 and the key 131 from the keyway 132 thereby allowing the clip accessory 124 to rotate. FIG. 16c shows the clip accessory 124 partially rotated. FIG. 16d shows the clip accessory 124 in the fully open position such that the key 131 again drops into the keyway 132 to retain the accessory clip 124 in the open position. Finally, at FIG. 16e, the clip accessory 124 has again been displaced away from the accessory mount 120 against the spring 127 thereby disengaging the key 131 from the keyway 132 thereby allowing the clip accessory 124 to rotate.

Turning now to FIG. 17, to further tailor the lighting assembly 100 to the desired military applications, the accessory mount 220 is shown to include a tap switch 224 extending therefrom in a manner that allows the lighting assembly 100 to be installed onto a weapon wherein the tape switch 224 is placed in a position that allows a user to easily access the tape switch 224 while also operating the weapon.

In this manner it can be seen that the present invention provides a completely sealed lighting assembly 10 is provided with a greater operational range than was previously known in the art, while also providing a modular interface that promotes integration of the lighting assembly 10 into a variety of configurations. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A modular flashlight system comprising
a flashlight having an outer housing, said outer housing that includes an opening in one end thereof, said opening formed as a modular interface; and
a modular accessory mount having a first end configured to be slidably received and retained by said modular interface thereby forming a seal with said opening in said outer housing and a second end configured to receive an accessory device, wherein said modular accessory mount is selectively removable from said flashlight.

2. The modular flashlight system of claim 1, wherein said accessory device is a hook.

3. The modular flashlight system of claim 2, wherein said hook is selectively rotatable relative to said flashlight.

4. The modular flashlight system of claim 2 wherein said hook and a base of said accessory device include corresponding mating formations that receive and selectively retain said hook in an open or closed position.

5. The modular flashlight system of claim 1, wherein said flashlight is a multi-functional flashlight.

6. The modular flashlight of claim 5, further comprising:
a user interface for selectively operating said flashlight.

7. The modular flashlight of claim 6, wherein said user interface further comprises:
a switch for selectively operating said flashlight and selectively changing the mode of said flashlight; and
an indicator that signals the mode for which the flashlight is set.

8. The modular flashlight of claim 5, wherein said multifunctionality of said flashlights includes different colors and different modes.

9. The modular flashlight of claim 8, wherein said color is selected from the group consisting of: white, red, blue, green, infrared and ultraviolet.

10. The modular flashlight of claim 8, wherein said mode is selected from the group consisting of: constant on, momentary on, strobe, high, low.

11. The modular flashlight system of claim 1, wherein said accessory device is a tape switch configured for remote operation of said flashlight.

12. The modular flashlight of claim 11, wherein said user tape switch further comprises:
a switch for selectively operating said flashlight and selectively changing a mode of said flashlight; and
an indicator on said flashlight that signals the mode for which the flashlight is set.

13. The modular flashlight of claim 12, wherein said flashlight can be selectively operated using different colors and different modes.

14. The modular flashlight of claim 13, wherein said color is selected from the group consisting of: white, red, blue, green, infrared and ultraviolet.

15. The modular flashlight of claim 13, wherein said mode is selected from the group consisting of: constant on, momentary on, strobe, high, low.
